(19) United States
(12) Patent Application Publication
(10) Pub. No.: US 2004/0001505 A1
(43) Pub. Date: Jan. 1, 2004

(54) Circuit for adding one to a binary number

(75) Inventors: Ken L. Motoyama, Cupertino, CA (US); Sudhendra V. Parampalli, Sunnyvale, CA (US)

Correspondence Address: Serge J. Hodgson, Gunnison, McKay & Hodgson, L.L.P., Suite 220, 1900 Garden Road, Monterey, CA, 93940, US

(73) Assignee: Sun Microsystems, Inc.

(21) Appl. No.: 10/185,158

(22) Filed: Jun. 27, 2002

(51) Int. Cl. H04L 12/66

(52) U.S. Cl. 370/463; 370/419

(57) ABSTRACT

A circuit for a plus one operation includes a means for incrementing a first bit set of a binary number and a means for detecting a zero in any bit set less significant than the first bit set, the means for detecting being coupled to the means for incrementing. The means for incrementing operates in a first mode when the means for detecting detects a zero in any bit set less significant than the first bit set and operates in a second mode when the means for detecting does not detect a zero in any bit set less significant than the first bit set.

### BACKGROUND OF THE INVENTION

1. Field of the Invention

The present invention relates to a method and apparatus for adding one to a binary number.

2. Description of the Related Art In several binary arithmetic operations, the number one must be added to an operand. This is often referred to as the plus one operation (+1 operation). For example, the +1 operation is used in quotient correction, counters and 2s complement generation.

The +1 operation is conventionally implemented with an adder as is well known to those of skill in the art. However, the circuitry of an adder is relatively slow, occupies a substantial amount of area on the integrated circuit chip, and is energy inefficient.

### SUMMARY OF THE INVENTION

In accordance with one embodiment of the present invention, a circuit for a plus one operation includes a means for incrementing a first bit set of a binary number and a means for detecting a zero in any bit set less significant than the first bit set, the means for detecting being coupled to the means for incrementing.

In one embodiment, the means for incrementing operates in a first mode when the means for detecting detects a zero in any bit set less significant than the first bit set and operates in a second mode when the means for detecting does not detect a zero in any bit set less significant than the first bit set.

The circuit is relatively fast, occupies a relatively small amount of area on the integrated circuit chip, and is energy efficient.

The present invention is best understood by reference to the following detailed description when read in conjunction with the accompanying drawings.

### BRIEF DESCRIPTION OF THE DRAWINGS

FIG. 1 is a flowchart of a plus one (+1) operation in accordance with one embodiment of the present invention;

FIG. 2 is a truth table for various relations in accordance with one embodiment of the present invention;

FIG. 3 is a key to FIGS. 3A, 3B, 3C, which are a circuit schematic diagram of exemplary bit set processing circuitry for processing a bit set in accordance with one embodiment of the present invention; and

FIG. 4 is a key to FIGS. 4A and 4B, which are a circuit schematic diagram of +1 circuitry for adding a one to a 32-bit binary number in accordance with one embodiment of the present invention.

Common reference numerals are used throughout the drawings and detailed description to indicate like elements.

### DETAILED DESCRIPTION

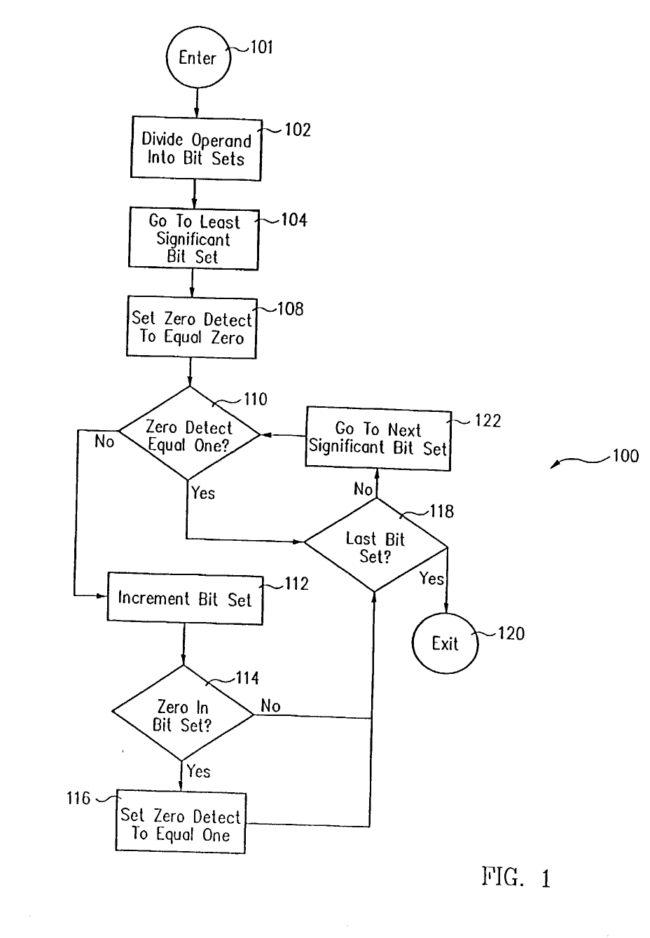

FIG. 1 is a flowchart 100 of a plus one (+1) operation in accordance with one embodiment of the present invention. Referring now to FIG. 1, from an enter operation 101, process flow moves to a divide operand into bit sets operation 102. In divide operand into bit sets operation 102, the operand is divided into groups of four bits. For example, for a 32-bit operand, the operand is divided into 8 groups of four bits.

From divide operand into bit sets operation 102, process flow moves to a go to least significant bit set operation 104. In go to least significant bit set operation 104, the least significant bit set, i.e., the least significant four bits of the operand, are selected as the current bit set to be operated upon.

From go to least significant bit set operation 104, process flow moves to a set zero detect to equal zero operation 108. In set zero detect to equal zero operation 108, the zero detect, i.e., a variable, is set to equal zero.

From set zero detect to equal zero operation 108, process flow moves to zero detect equal one operation 110. In zero detect equal one operation 110, a determination is made whether the zero detect equals one. If the zero detect does equal one, then process flow moves to last bit set operation 118 and the current bit set is left unchanged. If the zero detect does not equal one, i.e., equals zero, then process flow moves to increment bit set operation 112.

In this instance, since zero detect was set to equal zero in set zero detect to equal zero operation 108, a determination is made in zero detect equal one operation 110 that zero detect equals zero. Accordingly, process flow moves to increment bit set operation 112.

In increment bit set operation 112, the bit set is increment in one of two ways. If all bits of the bit set equal one, i.e., the bit set is 1111, then all bits of the bit set are simply complemented, sometimes called inverted, and set to zero. This is represented by relation 1:

1111->0000

In all other instances, the least significant zero of the bit set is identified, and the least significant zero and all less significant bits, i.e., everything to the right of the least significant zero, is (are) complemented. Examples are given below in relations 2, 3 and 4:

0000->0001 (2)

0010->0011 (3)

0011->0100 (4)

From increment bit set operation 112, process flow moves to a zero in bit set operation 114. In zero in bit set operation 114, a determination is made whether any of the bits of the bit set is equal to zero. If any of the bits of the bit set is equal to zero, then process flow moves to set zero detect to equal one operation 116. In set zero detect to equal one operation 116, zero detect is set to equal one. Process flow then moves from set zero detect to equal one operation 116 to last bit set operation 118.

Conversely, if a determination is made that none of the bits of the bit set is equal to zero in zero in bit set operation 114, i.e., that all bits of the bit set equal one, process flow moves directly to last bit set operation 118.

In last bit set operation 118, a determination is made as to whether the current bit set is the last bit set, sometimes called the most significant bit set, of the operand. If the current bit set is the last bit set, then process flow exits at an exit operation 120. If the current bit set is not the last bit set, i.e., there are more significant bit sets of the operand remaining, process flow moves to go to next significant bit set operation 122.

In go to next significant bit set operation 122, the next significant bit set, i.e., the next significant four bits of the operand, are selected as the current bit set to be operated upon. From go to next significant bit set operation 122, process flow returns to zero detect equal one operation 110.

Operations 110, 112, 114, 116, 118, 122 are repeated until a determination is made that the current bit set is the last bit set in last bit set operation 118, and process flow exits at exit operation 120.

As discussed above, in increment bit set operation 112, if the bit set is 1111, then all bits of the bit set are simply complemented and set to zero. In all other instances, the least significant zero of the bit set is identified, and the least significant zero and all less significant bits are complemented.

In accordance with one embodiment of the present invention, the values of the four bits of the bit set are represented by a<i>, a<i+1>, a<i+2>, a<i+3>. More particularly, a<i> is the value of the least significant bit, sometimes called the zero bit. a<i+1>, a<i+2> are the values of the next significant bits, sometimes called the first and second bits, respectively. Finally, a<i+3> is the value of the most significant bit, sometimes called the last or third bit.

The output values corresponding to the four bits of the bit set are represented by sum<i>, sum<i+1>, sum<i+2>, sum<i+3>. More particularly, sum<i> is the output value corresponding to the zero bit. Sum<i+1>, sum<i+2> are the output values corresponding to the first and second bits, respectively. Finally, sum<i+3> is the output value corresponding to the third bit.

In accordance with one embodiment, the output values corresponding to the four bits are calculated according to relations 5, 6, 7, and 8:

sum<i>=˜a<i> (5)

sum<i+1>=a<i+1>XOR a<i> (6)

sum<i+2>=a<i+2>XOR(a<i+1>AND a<i>) (7)

sum<i+3>=a<i+3>XOR(a<i+2>AND a<i+1>AND a<i>) (8)

In relation 5, ˜a<i> is equivalent to the compliment of a<i>.

Relations 7 and 8 are also represented by and equivalent to relations (9) and (10), respectively:

sum<i+2>=˜a<i+2>XOR(a<i+1>AND a<i>) (9)

sum<i+3>=˜a<i+3>XOR˜(a<i+2>AND a<i+1>AND a<i>) (10)

In relations 9 and 10, ˜a<i+2>, ˜(a<i+1>AND a<i>), and ˜(a<i+2>AND a<i+1>AND a<i>) are equivalent the complement of a<i+2>, (a<i+1>AND a<i>), a<i+3>, and (a<i+2>AND a<i+1>AND a<i>), respectively.

For clarity of illustration regarding relations 6, 7, and 8, Table 1 is a truth table for a two input XOR function and Tables 2 and 3 are two and three input AND functions, respectively.

TABLE 1

| a | b | output |
|---|---|---|
| 0 | 0 | 0 |
| 0 | 1 | 1 |
| 1 | 0 | 1 |
| 1 | 1 | 0 |

TABLE 2

| a | b | output |
|---|---|---|
| 0 | 0 | 0 |
| 0 | 1 | 0 |
| 1 | 0 | 0 |
| 1 | 1 | 1 |

TABLE 3

| a | b | c | output |
|---|---|---|---|
| 0 | 0 | 0 | 0 |
| 0 | 0 | 1 | 0 |
| 0 | 1 | 0 | 0 |
| 0 | 1 | 1 | 0 |
| 1 | 0 | 0 | 0 |
| 1 | 0 | 1 | 0 |
| 1 | 1 | 0 | 0 |
| 1 | 1 | 1 | 1 |

Although AND functions are set forth above, those of skill in the art will understand that the AND function can be implemented using other equivalent functions. For example, using De Morgan's theorem, the NOR function is equated to its equivalent AND circuit description. De Morgan's theorem is well known to those of skill in the art but is reiterated here for clarity of discussion.

Illustratively, a two input NOR gate is equivalent to a two input AND gate having inverted inputs. Also, a two input OR gate is equivalent to a two input NAND gate having inverted inputs. Thus, a NAND gate having inverted inputs is sometimes referred to as an OR gate. Also, an AND gate having inverted inputs is sometimes referred to as a NOR gate.

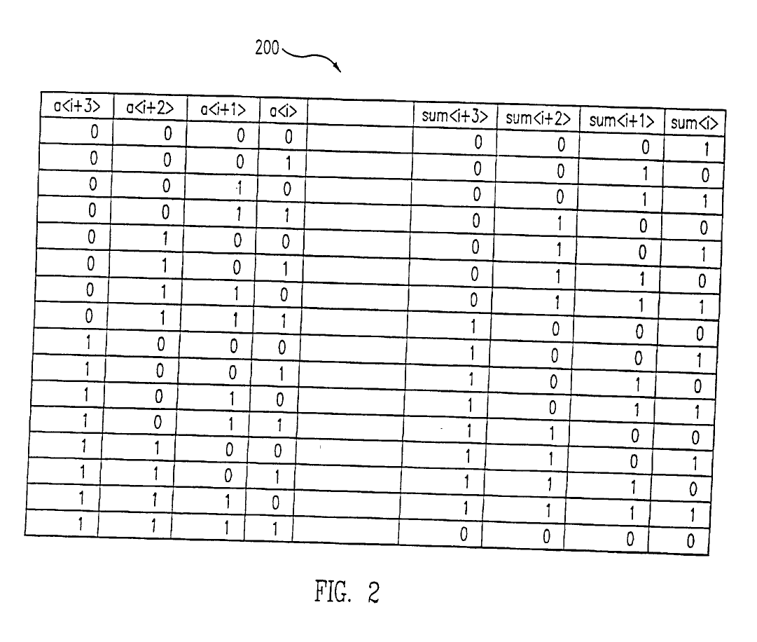

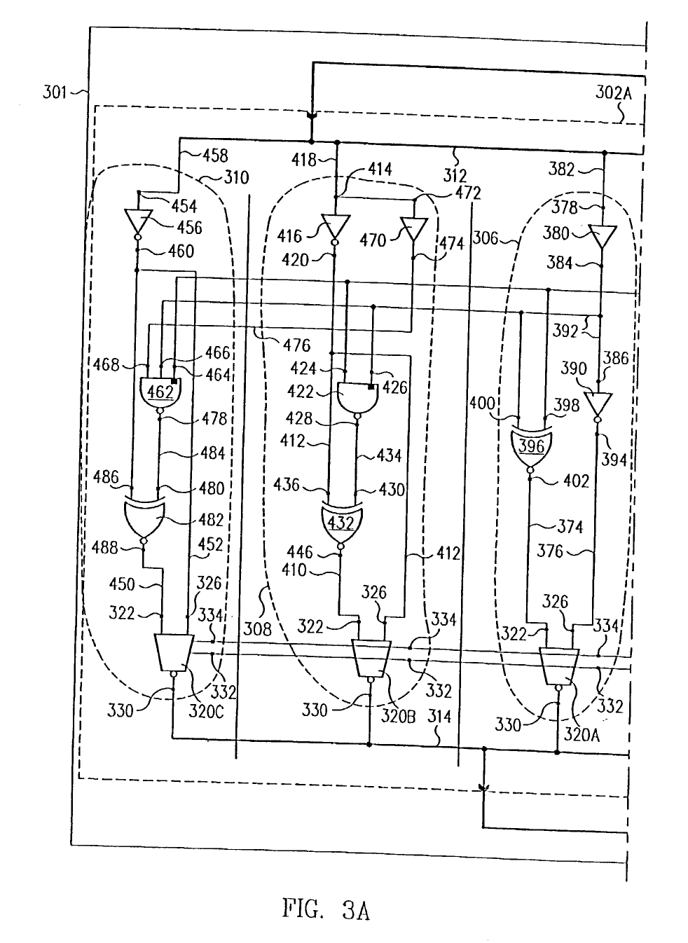

FIG. 2 is a truth table 200 for relations 5, 6, 7, and 8 in accordance with one embodiment of the present invention. As shown in FIG. 2, if the bit set equals 1111, then all bits of the bit set are simply complemented and set to zero. In all other instances, the least significant zero of the bit set is identified, and the least significant zero and all less significant bits are complemented.

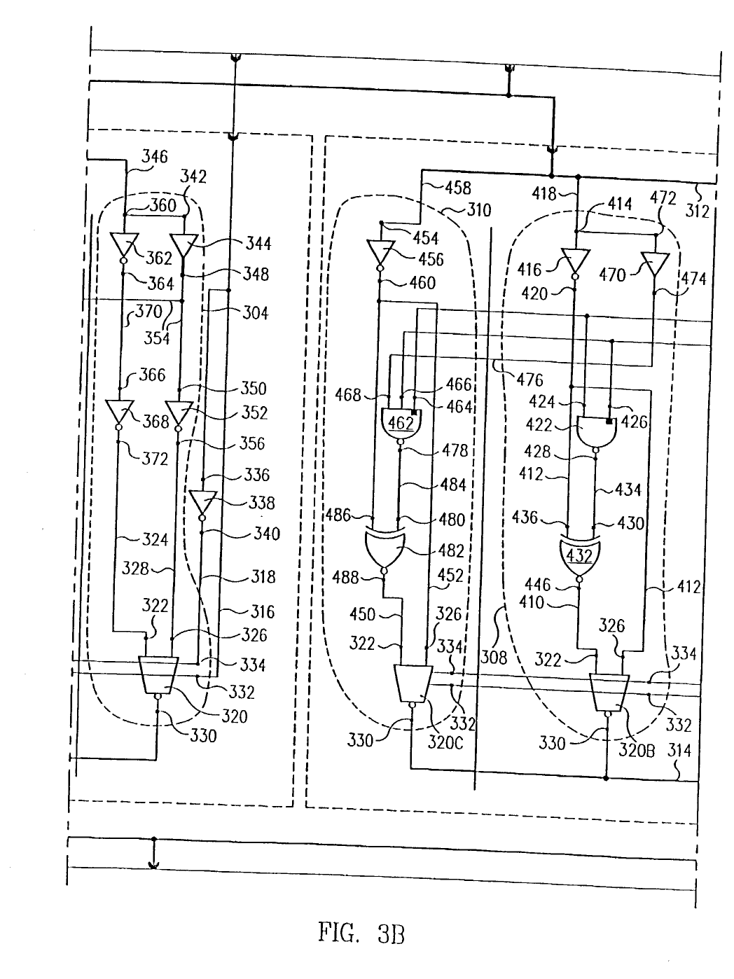

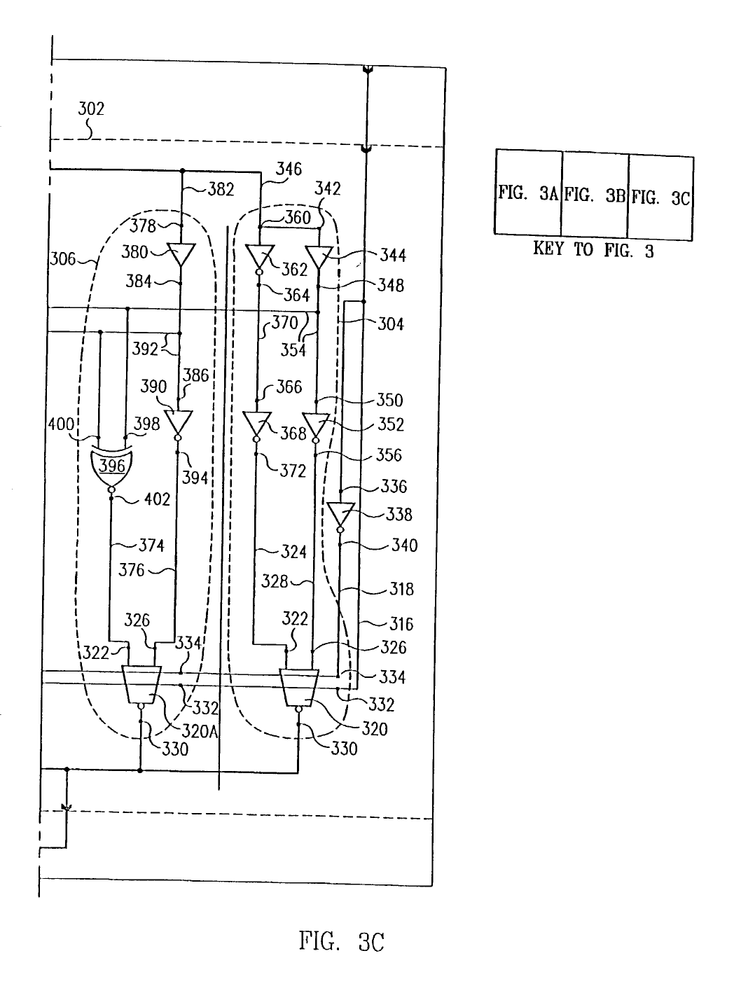

FIG. 3 is a key to FIGS. 3A, 3B, 3C, which are a circuit schematic diagram of exemplary bit set processing circuitry 301 for processing a bit set in accordance with one embodiment of the present invention. FIGS. 3A, 3B, and 3C are collectively referred to as FIG. 3.

Bit set processing circuitry 301 includes a first incrementing circuit 302 and a second incrementing circuit 302A. Incrementing circuit 302A is identical to incrementing circuit 302 and thus is only discussed briefly below to avoid detracting from the principals of the invention.

Incrementing circuit 302 includes a zero or least significant bit circuit 304, a first bit circuit 306, a second bit circuit 308, and a third or most significant bit circuit 310.

Incrementing circuit 302 is coupled to a data in bus 312, a data out bus 314, and a zero detect line 316. More particularly, zero bit circuit 304, first bit circuit 306, second bit circuit 308, and third bit circuit 310 are each coupled to data in bus 312, data out bus 314, zero detect line 316 (and an inverted zero detect line 318).

Zero bit circuit 304 includes an inverting multiplexer 320, hereinafter, a MUX 320. MUX 320 includes a line zero input port 322 coupled to a line zero 324, a line one input port 326 coupled to a line one 328 and a data out line output port 330 coupled to data out bus 314.

Further, MUX 320 includes a line one select port 332 coupled to zero detect line 316. In addition, MUX 320 includes a line zero select port 334 coupled to inverted zero detect line 318.

Zero detect line 316 is coupled to a zero detect line input port 336 of an inverter 338. Inverter 338 further includes an inverted zero detect line output port 340 coupled to inverted zero detect line 318.

When a logic one signal, sometimes called a logic high signal, is input to line one select port 332 (and accordingly, a logic zero signal, sometimes called a logic low signal, is input to line zero select port 334), line one input port 326 is the active port of MUX 320. Accordingly, the signal input to line one input port 326 is complemented by MUX 320 and the complemented signal is output on data out line output port 330 of MUX 320.

Conversely, when a logic one signal is input to line zero select port 334 (and, accordingly, a logic zero signal is input to line one select port 332), line zero input port 322 is the active port of MUX 320. Accordingly, the signal input to line zero input port 322 is complemented by MUX 320 and the complemented signal is output on data out line output port 330 of MUX 320.

The signal, hereinafter referred to as the zero detect signal, is provided on zero detect line 316 and thus input to line one select port 332 of MUX 320. The zero detect signal is also input to zero detect line input port 336 of inverter 338. The zero detect signal is a signal which represents the value (either one or zero) of the zero detect.

Inverter 338 complements the zero detect signal and the complemented zero detect signal is output at inverted zero detect line output port 340 of inverter 338. Line zero select port 334 of MUX 320 is coupled to inverted zero detect line output port 340 of inverter 338 by inverted zero detect line 318. Accordingly, the complemented zero detect signal is input to line zero select port 334 of MUX 320.

Generally, when the zero detect signal is a logic one signal, line one input port 326 is the active port of MUX 320. Accordingly, the signal input to line one input port 326 is complemented by MUX 320 and a complemented signal is output on data out line output port 330 of MUX 320.

The signal input to line one input port 326 of MUX 320 is simply a signal representing the complemented value of the least significant bit. Accordingly, when the zero detect signal is a logic one signal, a signal representing the value of the least significant bit is output on data out line output port 330 of MUX 320.

More particularly, data in bus 312 is coupled to an input port 342 of a buffer 344 by a zero bit line 346. Output port 348 of buffer 344 is coupled to an input port 350 of an inverter 352 by a line 354. Stated another way, inverter 352 is coupled to zero bit line 346 through buffer 344.

Output port 356 of inverter 352 is coupled to line one input port 326 of MUX 320 by line one 328. However, in an alternative embodiment, buffer 344 is not provided such that zero bit line 346 and line 354 form a common conductor, e.g., zero bit line 346 is directly coupled to input port 350 of inverter 352.

During use, a signal representing the value of the least significant bit, hereinafter referred to as the least significant bit signal, is provided from data in bus 312 to zero bit line 346. The least significant bit signal is complemented by inverter 352 and a signal representing the complemented value of the least significant bit, hereinafter referred to as the complemented least significant bit signal, is output from output port 356 of inverter 352. The complemented least significant bit signal is input into line one input port 326 of MUX 320. The complemented least significant bit signal is complemented by MUX 320 and the least significant bit signal is output on data out line output port 330 of MUX 320.

Conversely, when the zero detect signal is a logic zero signal, line zero input port 322 is the active port of MUX 320. Accordingly, the signal input to line zero input port 322 is complemented by MUX 320 and the complemented signal is output on data out line output port 330 of MUX 320.

The signal input to line zero input port 322 of MUX 320 is simply the least significant bit signal. Accordingly, when the zero detect signal is a logic zero signal, a complemented least significant bit signal is output on data out line output port 330 of MUX 320.

More particularly, data in bus 312 is coupled to an input port 360 of an inverter 362 by zero bit line 346. An output port 364 of inverter 362 is coupled to an input port 366 of an inverter 368 by a line 370. Output port 372 of inverter 368 is coupled to line zero input port 322 of MUX 320 by line zero 324. Stated another way, line zero input port 322 is coupled to zero bit line 346 through inverters 362, 368.

However, in an alternative embodiment, inverters 362, 368 and line 370 are not provided such that zero bit line 346 and line zero 324 form a common conductor, which is directly coupled to line zero input port 322 of MUX 320.

During use, the least significant bit signal is provided from data in bus 312 to zero bit line 346. The least significant bit signal is complemented by inverter 362 and a complemented least significant bit signal is output on output port 364. The complemented least significant bit signal is complemented by inverter 368 and a least significant bit signal is output on output port 372. The least significant bit signal is complemented by MUX 320 and a complemented least significant bit signal is output on data out line output port 330 of MUX 320.

First bit circuit 306 includes an inverting multiplexer 320A, hereinafter, MUX 320A. MUX 320A includes a line zero input port 322 coupled to a line zero 374, a line one input port 326 coupled to a line one 376 and a data out line output port 330 coupled to data out bus 314.

Further, MUX 320A includes a line one select port 332 coupled to zero detect line 316. In addition, MUX 320A includes a line zero select port 334 coupled to inverted zero detect line 318. MUX 320A is identical in usage and structure to MUX 320 and so is only briefly discussed to avoid detracting from the principals of the invention.

Generally, when the zero detect signal is a logic one signal, line one input port 326 is the active port of MUX 320A. Accordingly, the signal input to line one input port 326 is complemented by MUX 320A and the complemented signal is output on data out line output port 330 of MUX 320A.

The signal input to line one input port 326 of MUX 320A is simply a signal representing the complemented value of the first bit. Accordingly, when the zero detect signal is a logic one signal, a signal representing the value of the first bit is output on data out line output port 330 of MUX 320A.

More particularly, data in bus 312 is coupled to an input port 378 of a buffer 380 by a first bit line 382. Output port 384 of buffer 380 is coupled to an input port 386 of an inverter 390 by a line 392. Stated another way, input port 386 of inverter 390 is coupled to first bit line 382 through buffer 380.

Output port 394 of inverter 390 is coupled to line one input port 326 of MUX 320A by line one 376. However, in an alternative embodiment, buffer 380 is not provided such that first bit line 382 and line 392 form a common conductor, e.g., first bit line 382 is directly coupled to input port 386 of inverter 390.

During use, a signal representing the value of the first bit, hereinafter referred to as the first bit signal, is provided from data in bus 312 to first bit line 382. The first bit signal is complemented by inverter 390 and a signal representing the complemented value of the first bit, hereinafter referred to as the complemented first bit signal, is output from output port 394 of inverter 390. The complemented first bit signal is input into line one input port 326 of MUX 320A. The complemented first bit signal is complemented by MUX 320A and a first bit signal is output on data out line output port 330 of MUX 320A.

Conversely, when the zero detect signal is a logic zero signal, line zero input port 322 is the active port of MUX 320A. Accordingly, the signal input to line zero input port 322 is complemented by MUX 320A and the complemented signal is output on data out line output port 330 of MUX 320A.

The signal input to line zero input port 322 of MUX 320A is generated by executing the XNOR function on the least significant bit signal and the first bit signal. The XNOR function is well known to those of skill in the art and so is not discussed further to avoid detracting from the principals of the invention.

More particularly, first bit circuit 306 includes an XNOR gate 396. A least significant bit signal input port 398 of XNOR gate 396 is coupled to output port 348 of buffer 344 by line 354 and thereby to zero bit line 346. A first bit signal input port 400 of XNOR gate 396 is coupled to output port 384 of buffer 380 by line 392 and thereby to first bit line 382. An output port 402 of XNOR gate 396 is coupled to line zero input port 322 of MUX 320A by line zero 374.

During use, the least significant bit signal output from output port 348 of buffer 344 is input into least significant bit signal input port 398 of XNOR gate 396. The first bit signal output from output port 384 of buffer 380 is input into first bit signal input port 400 of XNOR gate 396. XNOR gate 396 executes the XNOR function on the least significant bit signal and the first bit signal and generates an XNOR output signal on output port 402 of a XNOR gate 396. The XNOR output signal is complemented by MUX 320A and a complemented XNOR output signal is output on data out line output port 330 of MUX 320A.

Second bit circuit 308 includes an inverting multiplexer 320B, hereinafter, MUX 320B. MUX 320B includes a line zero input port 322 coupled to a line zero 410, a line one input port 326 coupled to a line one 412 and a data out line output port 330 coupled to data out bus 314.

Further, MUX 320B includes a line one select port 332 coupled to zero detect line 316. In addition, MUX 320B includes a line zero select port 334 coupled to inverted zero detect line 318. MUX 320B is identical in usage and structure to MUX 320, MUX 320A and so is only briefly discussed to avoid detracting from the principals of the invention.

Generally, when the zero detect signal is a logic one signal, line one input port 326 is the active port of MUX 320B. Accordingly, the signal input to line one input port 326 is complemented by MUX 320B and the complemented signal is output on data out line output port 330 of MUX 320B.

The signal input to line one input port 326 of MUX 320B is simply a signal representing the complemented value of the second bit. Accordingly, when the zero detect signal is a logic one signal, a signal representing the value of the second bit is output on data out line output port 330 of MUX 320B.

More particularly, data in bus 312 is coupled to an input port 414 of an inverter 416 by a second bit line 418. An output port 420 of inverter 416 is coupled to line one input port 326 of MUX 320B by line one 412.

During use, a signal representing the value of the second bit, hereinafter referred to as the second bit signal, is provided from data in bus 312 to second bit line 418. The second bit signal is complemented by inverter 416 and a signal representing the complemented value of the second bit, hereinafter referred to as the complemented second bit signal, is output from output port 420 of inverter 416. The complemented second bit signal is input into line one input port 326 of MUX 320B. The complemented second bit signal is complemented by MUX 320B and a second bit signal is output on data out line output port 330 of MUX 320B.

Conversely, when the zero detect signal is a logic zero signal, line zero input port 322 is the active port of MUX 320B. Accordingly, the signal input to line zero input port 322 is complemented by MUX 320B and the complemented signal is output on data out line output port 330 of MUX 320B.

The signal input to line zero input port 322 of MUX 320B is generated in the following manner. Initially, the NAND function is executed on the least significant bit signal and the first bit signal to generate a NAND output signal. The NAND function is well known to those of skill in the art and so is not discussed further to avoid detracting from the principals of the invention. The XNOR function is executed on the NAND output signal and the inverted second bit signal to generate an XNOR output signal, which is input into line zero input port 322 of MUX 320B.

More particularly, second bit circuit 308 includes a NAND gate 422. A least significant bit signal input port 424 of NAND gate 422 is coupled to output port 348 of buffer 344 by line 354 and thereby to zero bit line 346. A first bit signal input port 426 of NAND gate 422 is coupled to output port 384 of buffer 380 by line 392 and thereby to first bit line 382. An output port 428 of NAND gate 422 is coupled to a NAND gate input port 430 of an XNOR gate 432 by a line 434.

A complemented second bit signal input port 436 of XNOR gate 432 is coupled to output port 420 of inverter 416 by line 412. An output port 446 of XNOR gate 432 is coupled to line zero input port 322 of MUX 320B by line zero 410.

During use, the least significant bit signal output from output port 348 of buffer 344 is input into least significant bit signal input port 424 of NAND gate 422. The first bit signal output from output port 384 of buffer 380 is input into first bit signal input port 426 of NAND gate 422. NAND gate 422 executes the NAND function on the least significant bit signal and the first bit signal and generates a NAND output signal on output port 428 of NAND gate 422.

The NAND output signal output from NAND gate 422 is input into NAND gate input port 430 of XNOR gate 432. The complemented second bit signal output from output port 420 of inverter 416 is input into complemented second bit signal input port 436 of XNOR gate 432. XNOR gate 432 executes the XNOR function on the NAND output signal and the complemented second bit signal and generates an XNOR output signal on output port 446 of XNOR gate 432. The XNOR output signal is complemented by MUX 320B and a complemented XNOR output signal is output on data out line output port 330 of MUX 320B.

Third bit circuit 310 includes an inverting multiplexer 320C, hereinafter, MUX 320C. MUX 320C includes a line zero input port 322 coupled to a line zero 450, a line one input port 326 coupled to a line one 452 and a data out line output port 330 coupled to data out bus 314.

Further, MUX 320C includes a line one select port 332 coupled to zero detect line 316. In addition, MUX 320C includes a line zero select port 334 coupled to inverted zero detect line 318. MUX 320C is identical in usage and structure to MUX 320, MUX 320A, MUX 320B and so is only briefly discussed to avoid detracting from the principals of the invention.

Generally, when the zero detect signal is a logic one signal, line one input port 326 is the active port of MUX 320C. Accordingly, the signal input to line one input port 326 is complemented by MUX 320C and the complemented signal is output on data out line output port 330 of MUX 320C.

The signal input to line one input port 326 of MUX 320C is simply a signal representing the complemented value of the third or most significant bit. Accordingly, when the zero detect signal is a logic one signal, a signal representing the value of the third bit is output on data out line output port 330 of MUX 320C.

More particularly, data in bus 312 is coupled to an input port 454 of an inverter 456 by a third bit line 458. An output port 460 of inverter 456 is coupled to line one input port 326 of MUX 320C by line one 452.

During use, a signal representing the value of the third bit, hereinafter referred to as the third bit signal, is provided from data in bus 312 to third bit line 458. The third bit signal is complemented by inverter 456 and a signal representing the complemented value of the third bit, hereinafter referred to as the complemented third bit signal, is output from output port 460 of inverter 456. The complemented third bit signal is input into line one input port 326 of MUX 320C. The complemented third bit signal is complemented by MUX 320C and a third bit signal is output on data out line output port 330 of MUX 320C.

Conversely, when the zero detect signal is a logic zero signal, line zero input port 322 is the active port of MUX 320C. Accordingly, the signal input to line zero input port 322 is complemented by MUX 320C and the complemented signal is output on data out line output port 330 of MUX 320C.

The signal input to line zero input port 322 of MUX 320C is generated in the following manner. Initially, the NAND function is executed on the least significant bit signal, the first bit signal, and the second bit signal to generate a NAND output signal. The XNOR function is executed on the NAND output signal and the complemented third bit signal to generate an XNOR output signal, which is input into line zero input port 322 of MUX 320C.

More particularly, third bit circuit 310 includes a NAND gate 462. A least significant bit signal input port 464 of NAND gate 462 is coupled to output port 348 of buffer 344 by line 354 and thereby to zero bit line 346. A first bit signal input port 466 of NAND gate 462 is coupled to output port 384 of buffer 380 by line 392 and thereby to first bit line 382.

A second bit signal input port 468 of NAND gate 462 is coupled to second bit line 418 through a buffer 470 of second bit circuit 308. More particularly, an input port 472 of buffer 470 is coupled to second bit line 418. An output port 474 of buffer 470 is coupled to second bit signal input port 468 of NAND gate 462 by a line 476. However, in an alternative embodiment, buffer 470 is not provided and second bit signal input port 468 of NAND gate 462 is directly coupled to second bit line 418.

An output port 478 of NAND gate 462 is coupled to NAND gate input port 480 of an XNOR gate 482 by a line 484. A complemented third bit signal input port 486 of XNOR gate 482 is coupled to output port 460 of inverter 456 by line one 452. An output port 488 of XNOR gate 482 is coupled to line zero input port 322 of MUX 320C by line zero 450.

During use, the least significant bit signal output from output port 348 of buffer 344 is input into least significant bit signal input port 464 of NAND gate 462. The first bit signal output from output port 384 of buffer 380 is input into first bit signal input port 466 of NAND gate 462. The second bit signal output from output port 474 of buffer 470 is input into second bit signal input port 468 of NAND gate 462. NAND gate 462 executes the NAND function on the least significant bit signal, the first bit signal, and the second bit signal and generates a NAND output signal on output port 478 of NAND gate 462.

The NAND output signal from NAND gate 462 is input into NAND gate input port 480 of XNOR gate 482. The complemented third bit signal output from output port 460 of inverter 456 is input into complemented third bit signal input port 486 of XNOR gate 482. XNOR gate 482 executes the XNOR function on the NAND gate output signal and the complemented third bit signal and generates an XNOR output signal on output port 488 of XNOR gate 482. The XNOR output signal is complemented by MUX 320C and a complemented XNOR output signal is output on data out line output port 330 of MUX 320C.

As discussed above, zero, first, second, and third bit circuit 304, 306, 308 and 310, respectively, operate in a first mode when the zero detect signal is zero, i.e., is in a first state, and operate in a second mode when the zero detect signal is one, i.e., is in a second state.

More particularly, referring to FIGS. 1 and 3 together, if the zero detect and thus zero detect signal equals zero as discussed above in reference to zero detect equal one operation 110, process flow moves to increment bit set operation 112. In increment bit set operation 112, zero, first, second, and third bit circuits 304, 306, 308 and 310, respectively, increment the bit set as discussed above in the instance when the zero detect signal equals zero.

Conversely, if the zero detect and thus zero detect signal equals one, process flow moves from zero detect equal one operation 110 to last bit set operation 118 and the current bit set is left unchanged. In this case, zero, first, second, and third bit circuits 304, 306, 308 and 310, respectively, simply pass the bit set through unchanged as discussed above in the instance when the zero detect signal equals one.

As discussed above in reference to set zero detect to equal zero operation 108 of FIG. 1, initially, the zero detect and thus zero detect signal is set to equal zero. Then, for each current bit set, all previous bit sets are analyzed to determine whether any of the previous bit sets contained a zero. If any of the previous bit sets contained a zero, the zero detect and thus zero detect signal are set equal to one. In accordance with one embodiment, a NAND function is executed on the previous bit signals, i.e., signals representing the values of the previous bits, to determine whether any of the previous bit sets contained a zero.

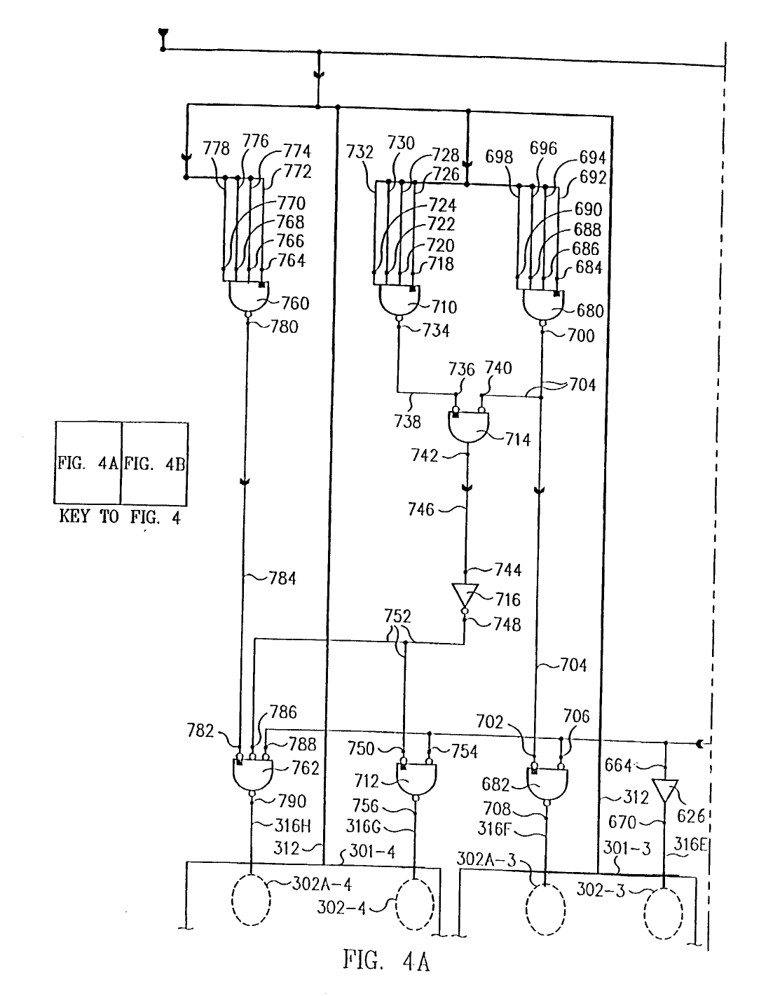

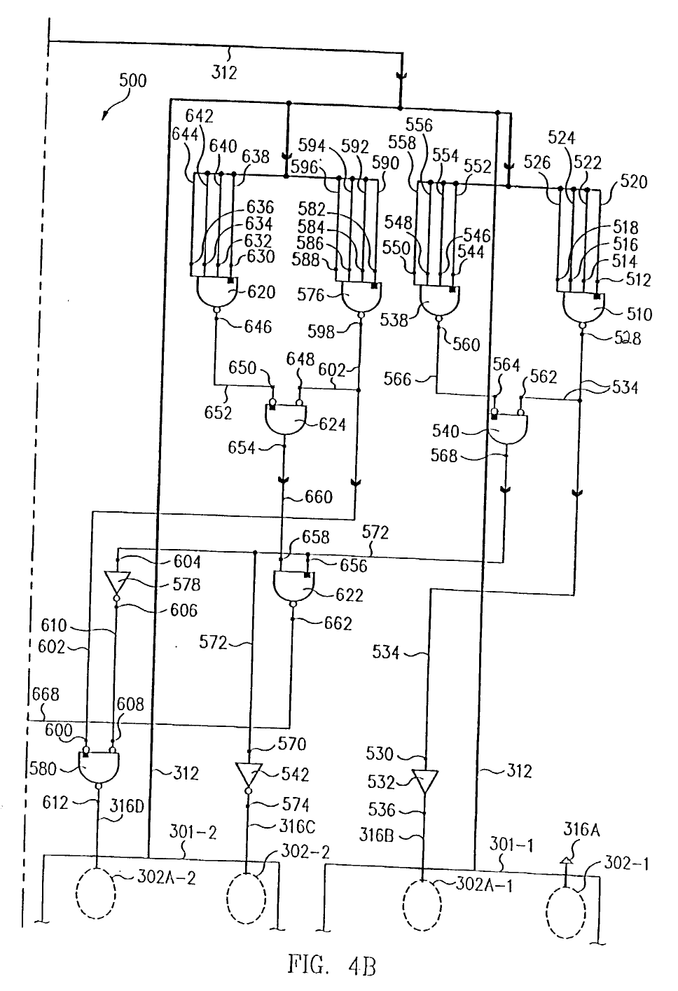

FIG. 4 is a key to FIGS. 4A and 4B, which are a circuit schematic diagram of +1 circuitry 500 for adding a one to a 32-bit binary number in accordance with one embodiment of the present invention. FIGS. 4A and 4B are collectively referred to as FIG. 4.

+1 circuitry 500 includes four bit set processing circuitry 301-1, 301-2, 301-3, 301-4, collectively bit set processing circuitry 301. Each bit set processing circuitry 301 includes a first incrementing circuit 302 and a second incrementing circuit 302A as discussed above in detail in reference to FIG. 3. +1 circuitry 500 also includes zero detect signal generating circuitry as discussed below.

Referring now to incrementing circuit 302-1 of bit set processing circuitry 301-1, incrementing circuit 302-1 processes the first bit set, i.e., bits 0-3, of the 32-bit binary number. The operation of incrementing circuit 302-1 is controlled by the zero detect signal provided on zero detect line 316A.

The zero detect signal provided on zero detect line 316A is permanently set to zero. More particularly, since there are no previous bit sets, a zero in a previous bit set does not and will never exist, thus the zero detect signal provided on zero detect line 316A is permanently set to zero.

Referring now to incrementing circuit 302A-1 of bit set processing circuitry 301-1, incrementing circuit 302A-1 processes the next bit set, i.e., bits 4-7, of the 32-bit binary number. The operation of incrementing circuit 302A-1 is controlled by the zero detect signal provided on zero detect line 316B.

The zero detect signal provided on zero detect line 316B is set to zero if there are no zeros in the first bit set, i.e., in bits 0-3, and is set to one if any of the bits of the first bit set are zero. The zero detect signal provided on zero detect line 316B is generated by a NAND gate 510.

NAND gate 510 includes zero, first, second, and third bit input ports 512, 514, 516 and 518 coupled to data in bus 312 by zero, first, second, and third bit lines 520, 522, 524 and 526, respectively. During use, the zero, first, second and third bit signals are input into zero, first, second, and third bit input ports 512, 514, 516 and 518 of NAND gate 510. NAND gate 510 executes the NAND function on the zero, first, second and third bit signals and generates a zero detect signal, sometimes called a 0-3 NAND gate output signal, at an output port 528 of NAND gate 510.

Output port 528 of NAND gate 510 is coupled to an input port 530 of a buffer 532 by a line 534. An output port 536 of buffer 532 is coupled to zero detect line 316B. However, in an alternative embodiment, buffer 532 and line 534 are not provided such that zero detect line 316B is directly coupled to output port 528 of NAND gate 510.

Referring now to incrementing circuit 302-2 of bit set processing circuitry 301-2, incrementing circuit 302-2 processes the next bit set, i.e., bits 8-11, of the 32-bit binary number. The operation of incrementing circuit 302-2 is controlled by the zero detect signal provided on zero detect line 316C.

The zero detect signal provided on zero detect line 316C is set to zero if there are no zeros in the first and second bit sets, i.e., in bits 0-7, and is set to one if any of the bits of the first and second bit sets are zero. The zero detect signal provided on zero detect line 316C is generated by NAND gate 510, NAND gate 538, a NOR gate 540 and an inverter 542.

NAND gate 538 includes fourth, fifth, sixth, and seventh bit input ports 544, 546, 548 and 550 coupled to data in bus 312 by fourth, fifth, sixth, and seventh bit lines 552, 554, 556 and 558, respectively. During use, the fourth, fifth, sixth, and seventh bit signals are input into fourth, fifth, sixth, and seventh bit input ports 544, 546, 548 and 550 of NAND gate 538. NAND gate 538 executes the NAND function on the fourth, fifth, sixth, and seventh bit signals and generates a 4-7 NAND gate output signal at an output port 560 of NAND gate 538.

Output port 528 of NAND gate 510 is coupled to a 0-3 input port 562 of NOR gate 540 by line 534. Output port 560 of NAND gate 538 is coupled to a 4-7 input port 564 of NOR gate 540 by line 566. NOR gate 540 complements the 0-3 NAND gate output signal from NAND gate 510 and complements the 4-7 NAND gate output signal from NAND gate 538. NOR gate 540 executes the AND function on the complemented 0-3 NAND gate output signal and the complemented 4-7 NAND gate output signal and generates a 0-7 NOR gate output signal at an output port 568 of NOR gate 540.

The 0-7 NOR gate output signal is complemented by inverter 542 and the result is output as the zero detect signal on zero detect line 316C. More particularly, an input port 570 of inverter 542 is coupled to output port 568 of NOR gate 540 by a line 572. An output port 574 of inverter 542 is coupled to zero detect line 316C.

Referring now to incrementing circuit 302A-2 of bit set processing circuitry 301-2, incrementing circuit 302A-2 processes the next bit set, i.e., bits 12-15, of the 32-bit binary number. The operation of incrementing circuit 302A-2 is controlled by the zero detect signal provided on zero detect line 316D.

The zero detect signal provided on zero detect line 316D is set to zero if there are no zeros in the first, second and third bit sets, i.e., in bits 0-11, and is set to one if any of the bits of the first, second and third bit sets are zero. The zero detect signal provided on zero detect line 316D is generated by NAND gate 510, NAND gate 538, NOR gate 540, a NAND gate 576, an inverter 578 and an OR gate 580.

NAND gate 576 includes eighth, ninth, 10th and 11th bit input ports 582, 584, 586, and 588 coupled to data in bus 312 by eighth, ninth, 10th and 11th bit lines 590, 592, 594 and 596, respectively.

During use, the eighth, ninth, 10th and 11th bit signals are input into eighth, ninth, 10th and 11th bit input ports 582, 584, 586, and 588 of NAND gate 576. NAND gate 576 executes the NAND function on the eighth, ninth, 10th and 11th bit signals and generates an 8-11 NAND gate output signal at an output port 598 of NAND gate 576. Output port 598 of NAND gate 576 is coupled to an 8-11 input port 600 of OR gate 580 by line 602.

Output port 568 of NOR gate 540 is coupled to an input port 604 of inverter 578 by line 572. Inverter 578 complements the 0-7 NOR gate output signal output from NOR gate 540 and the result is output as a complemented 0-7 NOR gate output signal.

An output port 606 of inverter 578 is coupled to a 0-7 input port 608 of OR gate 580 by a line 610. OR gate 580 complements the 8-11 NAND gate output signal and complements the complemented 0-7 NOR gate output signal (resulting in a 0-7 NOR gate output signal). OR gate 580 executes the NAND function on the complemented 8-11 NAND gate output signal and 0-7 NOR gate output signal to generate a zero detect signal at an output port 612 of OR gate 580. Output port 612 of OR gate 580 is coupled to zero detect line 316D.

Referring now to incrementing circuit 302-3 of bit set processing circuitry 301-3, incrementing circuit 302-3 processes the next bit set, i.e., bits 16-19, of the 32-bit binary number. The operation of incrementing circuit 302-3 is controlled by the zero detect signal provided on zero detect line 316E.

The zero detect signal provided on zero detect line 316E is set to zero if there are no zeros in the first, second, third and fourth bit sets, i.e., in bits 0-15, and is set to one if any of the bits of the first, second, third and fourth bit sets are zero. The zero detect signal provided on zero detect line 316E is generated by NAND gates 510, 538, 576, 620, 622, NOR gates 540, 624 and a buffer 626.

NAND gate 620 includes 12th, 13th, 14th, 15th bit input ports 630, 632, 634 and 636 coupled to data in bus 312 by 12th, 13th, 14th, 15th bit lines 638, 640, 642 and 644, respectively.

During use, the 12th, 13th, 14th, 15th bit signals are input into 12th, 13th, 14th, 15th bit input ports 630, 632, 634 and 636 of NAND gate 620. NAND gate 620 executes the NAND function on the 12th, 13th, 14th, 15th bit signals and generates a 12-15 NAND gate output signal at an output port 646 of NAND gate 620.

Output port 598 of NAND gate 576 is coupled to a 8-11 input port 648 of NOR gate 624 by line 602. Output port 646 of NAND gate 620 is coupled to a 12-15 input port 650 of NOR gate 624 by a line 652.

NOR gate 624 complements the 8-11 NAND gate output signal from NAND gate 576 and complements the 12-15 NAND gate output signal from NAND gate 620. NOR gate 624 executes the AND function on the complemented 8-11 NAND gate output signal and the complemented 12-15 NAND gate output signal and generates an 8-15 NOR gate output signal at an output port 654 of NOR gate 624.

Output ports 568, 654 of NOR gates 540, 624 are coupled to 0-7, 8-15 input ports 656, 658 of NAND gate 622 by lines 572, 660, respectively. NAND gate 622 executes the NAND function on the 0-7 NOR gate output signal from NOR gate 540 and the 8-15 NOR gate output signal from NOR gate 624 to generate a zero detect signal, sometimes called a 0-15 NAND gate output signal, at an output port 662 of NAND gate 622.

Output port 662 of NAND gate 622 is coupled to an input port 664 of buffer 626 by a line 668. An output port 670 of buffer 626 is coupled to zero detect line 316E. However, in an alternative embodiment, buffer 626 and line 668 are not provided such that zero detect line 316E is directly coupled to output port 662 of NAND gate 622.

Referring now to incrementing circuit 302A-3 of bit set processing circuitry 301-3, incrementing circuit 302A-3 processes the next bit set, i.e., bits 20-23, of the 32-bit binary number. The operation of incrementing circuit 302A-3 is controlled by the zero detect signal provided on zero detect line 316F.

The zero detect signal provided on zero detect line 316F is set to zero if there are no zeros in the first, second, third, fourth and fifth bit sets, i.e., in bits 0-19, and is set to one if any of the bits of the first, second, third, fourth and fifth bit sets are zero. The zero detect signal provided on zero detect line 316F is generated by NAND gates 510, 538, 576, 620, 680, 622, NOR gates 540, 624, and an OR gate 682.

NAND gate 680 includes 16th, 17th, 18th and 19th bit input ports 684, 686, 688, and 690 coupled to data in bus 312 by 16th, 17th, 18th and 19th bit lines 692, 694, 696 and 698, respectively.

During use, the 16th, 17th, 18th and 19th bit signals are input into 16th, 17th, 18th and 19th bit input ports 684, 686, 688, and 690 of NAND gate 680. NAND gate 680 executes the NAND function on the 16th, 17th, 18th and 19th bit signals and generates a 16-19 NAND gate output signal at an output port 700 of NAND gate 680. Output port 700 of NAND gate 680 is coupled to a 16-19 input port 702 of OR gate 682 by a line 704.

Output port 662 of NAND gate 622 is coupled to a 0-15 input port 706 of OR gate 682 by line 668. OR gate 682 complements the 0-15 NAND gate output signal from NAND gate 622 and complements the 16-19 NAND gate output signal from NAND gate 680. OR gate 682 executes the NAND function on the complemented 0-15 NAND gate output signal and the complemented 16-19 NAND gate output signal to generate a zero detect signal at an output port 708 of OR gate 682. Output port 708 of OR gate 682 is coupled to zero detect line 316F.

Referring now to incrementing circuit 302-4 of bit set processing circuitry 301-4, incrementing circuit 302-4 processes the next bit set, i.e., bits 24-27, of the 32-bit binary number. The operation of incrementing circuit 302-4 is controlled by the zero detect signal provided on zero detect line 316G.

The zero detect signal provided on zero detect line 316G is set to zero if there are no zeros in the first, second, third, fourth, fifth and sixth bit sets, i.e., in bits 0-23, and is set to one if any of the bits of the first, second, third, fourth, fifth, and sixth bit sets are zero. The zero detect signal provided on zero detect line 316G is generated by NAND gates 510, 538, 576, 620, 622, 680, 710, NOR gates 540, 624, 714, an inverter 716, and an OR gate 712.

NAND gate 710 includes 20th, 21st, 22nd, 23rd bit input ports 718, 720, 722, 724 coupled to data in bus 312 by 20th, 21st, 22nd, 23rd bit lines 726, 728, 730, 732, respectively.

During use, the 20th, 21st, 22nd, 23rd bit signals are input into 20th, 21st, 22nd, 23rd bit input ports 718, 720, 722, and 724 of NAND gate 710. NAND gate 710 executes the NAND function on the 20th, 21st, 22nd, 23rd bit signals and generates a 20-23 NAND gate output signal at an output port 734 of NAND gate 710. Output port 734 of NAND gate 710 is coupled to a 20-23 input port 736 of NOR gate 714 by line 738.

Output port 700 of NAND gate 680 is coupled to a 16-19 input port 740 of NOR gate 714 by line 704. NOR gate 714 complements the 16-19 NAND gate output signal from NAND gate 680 and complements the 20-23 NAND gate output signal from NAND gate 710. NOR gate 714 executes the AND function on the complemented 16-19 NAND gate output signal and the complemented 20-23 NAND gate output signal to generate a 16-23 NOR gate output signal at an output port 742 of NOR gate 714. Output port 742 of NOR gate 714 is coupled to an input port 744 of inverter 716 by a line 746.

Inverter 716 complements the 16-23 NOR gate output signal and outputs a complemented 16-23 NOR gate output signal at an output port 748 of inverter 716. Output port 748 of inverter 716 is coupled to a 16-23 input port 750 of OR gate 712 by a line 752. Output port 662 of NAND gate 622 is coupled to a 0-15 input port 754 of OR gate 712 by line 668.

OR gate 712 complements the 0-15 NAND gate output signal from NAND gate 622 and complements the complemented 16-23 NOR gate output signal from inverter 716 (to generate a 16-23 NOR gate output signal). OR gate 712 executes the NAND function on the complemented 0-15 NAND gate output signal and the 16-23 NOR gate output signal to generate a zero detect signal at an output port 756 of OR gate 712. Output port 756 of OR gate 712 is coupled to zero detect line 316G.

Referring now to incrementing circuit 302A-4 of bit set processing circuitry 301-4, incrementing circuit 302A-4 processes the next bit set, i.e., bits 28-31, of the 32-bit binary number. The operation of incrementing circuit 302A-4 is controlled by the zero detect signal provided on zero detect line 316H.

The zero detect signal provided on zero detect line 316H is set to zero if there are no zeros in the first, second, third, fourth, fifth, sixth, and seventh bit sets, i.e., in bits 0-27, and is set to one if any of the bits of the first, second, third, fourth, fifth, sixth, and seventh bit sets are zero. The zero detect signal provided on zero detect line 316H is generated by NAND gates 510, 538, 576, 620, 622, 680, 710, 760, NOR gates 540, 624, 714, inverter 716, and an OR gate 762.

NAND gate 760 includes 24th, 25th, 26th, 27th bit input ports 764, 766, 768 and 770 coupled to data in bus 312 by 24th, 25th, 26th, 27th bit lines 772, 774, 776, 778, respectively.

During use, the 24th, 25th, 26th, 27th bit signals are input into 24th, 25th, 26th, 27th bit input ports 764, 766, 768, 770 of NAND gate 760. NAND gate 760 executes the NAND function on the 24th, 25th, 26th, 27th bit signals and generates a 24-27 NAND gate output signal at an output port 780 of NAND gate 760.

Output port 780 of NAND gate 760 is coupled to a 24-27 input port 782 of OR gate 762 by line 784. Output port 748 of inverter 716 is coupled to a 16-23 input port 786 of OR gate 762 by line 752. Output port 662 of NAND gate 622 is coupled to a 0-15 input port 788 of OR gate 762 by line 668.

OR gate 762 complements the 0-15 NAND gate output signal from NAND gate 622, the complemented 16-23 NOR gate output signal from inverter 716 (to generate a 16-23 NOR gate output signal), and the 24-27 NAND gate output signal from NAND gate 760. OR gate 762 executes the NAND function on the complemented 0-15 NAND gate output signal, the 16-23 NOR gate output signal, and the complemented 24-27 NAND gate output signal to generate a zero detect signal at an output port 790 of OR gate 762. Output port 790 of OR gate 762 is coupled to zero detect line 316H.

Bit set processing circuitry 301 of FIG. 4 in accordance with the present invention is relatively fast, occupies a relatively small amount of area on the integrated circuit chip, and is energy efficient.

Although a +1 operation and circuitry for a 32-bit binary number is set forth above, in light of this disclosure, those of skill in the art will recognize that the principles in accordance with the present invention are applicable to a +1 operation and circuitry on a binary number having any one of a number of bits. For example, a +1 operation on a 64-bit binary number is performed with a circuit in accordance with one embodiment of the present invention.

This disclosure provides exemplary embodiments of the present invention. The scope of the present invention is not limited by these exemplary embodiments. Numerous variations, whether explicitly provided for by the specification or implied by the specification or not, may be implemented by one of skill in the art in view of this disclosure.

What is claimed is:

1. A circuit for a plus one operation comprising:
a first incrementing circuit comprising:
a zero bit circuit;
a first bit circuit;
a second bit circuit; and
a third bit circuit.

2. The circuit of claim 1 wherein said zero bit circuit comprises:
an inverting multiplexer comprising:
a line zero input port;
a line one input port;
a first inverter having an output port coupled to said line one input port.

3. The circuit of claim 2 further comprising a zero bit line coupled to an input port of said first inverter and coupled to said line zero input port of said inverting multiplexer.

4. The circuit of claim 2 wherein said zero bit line is coupled to said input port of said first inverter through a buffer.

5. The circuit of claim 2 wherein said zero bit line is coupled to said line zero input port of said inverting multiplexer through a second inverter and a third inverter.

6. The circuit of claim 1 wherein said first bit circuit comprises:
an inverting multiplexer comprising:
a line zero input port;
a line one input port;
a first inverter having an output port coupled to said line one input port.

7. The circuit of claim 6 further comprising a first bit line coupled to an input port of said first inverter.

8. The circuit of claim 7 wherein said first bit line is coupled to said input port of said first inverter through a buffer.

9. The circuit of claim 6 further comprising an XNOR gate having an output port coupled to said line zero input port of said inverting multiplexer.

10. The circuit of claim 9 further comprising:
a zero bit line coupled to a least significant bit signal input port of said XNOR gate; and
a first bit line coupled to a first bit signal input port of said XNOR gate.

11. The circuit of claim 10 wherein said zero bit line is coupled to said least significant bit signal input port of said XNOR gate through a first buffer, and wherein said first bit line is coupled to said first bit signal input port of said XNOR gate through a second buffer.

12. The circuit of claim 1 wherein said second bit circuit comprises:
an inverting multiplexer comprising:
a line zero input port;
a line one input port;
a first inverter having an output port coupled to said line one input port.

13. The circuit of claim 12 further comprising a second bit line coupled to an input port of said first inverter.

14. The circuit of claim 12 further comprising an XNOR gate having an output port coupled to said line zero input port of said inverting multiplexer.

15. The circuit of claim 14 further comprising:
a NAND gate having an output port coupled to a NAND gate input port of said XNOR gate;
a zero bit line coupled to a least significant bit signal input port of said NAND gate; and
a first bit line coupled to a first bit signal input port of said NAND gate.

16. The circuit of claim 15 wherein said output port of said first inverter is coupled to an inverted second bit signal input port of said XNOR gate.

17. The circuit of claim 1 wherein said third bit circuit comprises:
an inverting multiplexer comprising:
a line zero input port;
a line one input port;
a first inverter having an output port coupled to said line one input port.

18. The circuit of claim 17 further comprising a third bit line coupled to an input port of said first inverter.

19. The circuit of claim 17 further comprising an XNOR gate having an output port coupled to said line zero input port of said inverting multiplexer.

20. The circuit of claim 19 further comprising:
a NAND gate having an output port coupled to a NAND gate input port of said XNOR gate;
a zero bit line coupled to a least significant bit signal input port of said NAND gate; and
a first bit line coupled to a first bit signal input port of said NAND gate; and
a second bit line coupled to a second bit signal input port of said NAND gate.

21. The circuit of claim 20 wherein said output port of said first inverter is coupled to an inverted third bit signal input port of said XNOR gate.

22. The circuit of claim 1 further comprising a zero detect line coupled to said zero bit circuit, said first bit circuit, said second bit circuit, and said third bit circuit.

23. The circuit of claim 1 further comprising a second incrementing circuit comprising:
a zero bit circuit;
a first bit circuit;
a second bit circuit; and
a third bit circuit.

24. The circuit of claim 23 further comprising:
a first zero detect line coupled to said first incrementing circuit; and
a second zero detect line coupled to said second incrementing circuit.

25. A circuit for a plus one operation comprising:
a first incrementing circuit for incrementing a first bit set comprising a zero bit, a first bit, a second bit and a third bit of a binary number;
a second incrementing circuit for incrementing a second bit set comprising a fourth bit, a fifth bit, a sixth bit and a seventh bit of said binary number;
a zero detect circuit comprising:
a NAND gate comprising:
a zero bit line input port;
a first bit line input port;
a second bit line input port;
a third bit line input port; and
an output port coupled to said second incrementing circuit,
a zero bit line coupled to said zero bit line input port;
a first bit line coupled to said first bit line input port;
a second bit line coupled to said second bit line input port; and
a third bit line coupled to said third bit line input port.

26. A circuit for a plus one operation comprising:
a means for incrementing a first bit set of a binary number;
a means for detecting a zero in any bit set less significant than said first bit set, said means for detecting coupled to said means for incrementing.

27. The circuit of claim 26 wherein said means for incrementing operates in a first mode when said means for detecting detects a zero in any bit set less significant than said first bit set.

28. The circuit of claim 27 wherein said means for incrementing operates in a second mode when said means for detecting does not detect a zero in any bit set less significant than said first bit set.
